(19) United States
(12) Patent Application Publication
(10) Pub. No.: US 2003/0174039 A1
(43) Pub. Date: Sep. 18, 2003

(54) Partial core, low frequency transformer

(76) Inventors: Patrick Selwyn Bodger, Christchurch (NZ); Wade Grant Enright, Christchurch (NZ); Mattew Bryan O'Neill, Christchurch (NZ); Ming Chuen Liew, Christchurch (NZ)

Correspondence Address: Chester E Flavin, McCormick Paulding & Huber, City Place II, 185 Asylum Street, Hartford, CT, 06103-4102, US

(21) Appl. No.: 10/275,668

(22) PCT Filed: May 11, 2001
(86) PCT No.: PCT/NZ01/00089

(30) Foreign Application Priority Data
May 11, 2000 (NZ) 504474

(51) Int. Cl. H01F 27/28

(52) U.S. Cl. 336/223

(57) ABSTRACT

A transformer (1) which is designed to operate in the low frequency range (30-300 Hz) at a primary voltage at the order of 100V or above; the transformer (1) includes primary winding (3), secondary winding (4) and a partial core (2); the primary and secondary windings are of electrically conductive material and are configured so that they at least partially surround the partial core (2); the primary and secondary windings are electrically insulated both from each other and from the partial core (2) and are arranged such that a magnetic flux generated by the application of an alternating current to one of the windings links the other winding and induces a voltage therein; the partial core is made of ferromagnetic material and does not form a closed continuous magnetic path.

### TECHNICAL FIELD

The present invention relates to an improved transformer design by combining a previously unexplored combination of design parameters.

### BACKGROUND ART

As is well known, a transformer is designed to connect independent alternating current (AC) electrical networks at different voltages and typically comprises two or more electrically isolated windings. An AC voltage applied to one winding induces a voltage in the other winding via the intermediary of a magnetic field. There has been extensive research in transformer design and applications, such that the key performance characteristics such as frequency, voltage and operating temperature extend over a wide spectrum, whilst the transformer may utilize either a full-core, a partial core, or be completely core-less.

The design of the transformer is greatly affected by the nature of its intended use. The present invention relates to a power transformer and utilizes a particular combination of design parameters which surprisingly has hitherto been unexplored.

The intended operating temperature also affects the transformer design, configuration and constituent materials and may be generally classified as follows:

high temperatures exceeding those tolerable by humans, typically created in artificial environments,

the ambient temperatures encompassing the range of naturally encountered climatic conditions, e.g. frost/ice to high-temperature deserts. The internal heat generated by the operation of transformers may cause the actual operating temperature to exceed ambient,

high temperature super-conducting temperatures provided by operations in a liquid nitrogen environment,

to low temperature super-conducting temperatures provided by operations in a liquid helium environment.

Whilst frequency and voltage may seem at face value to be a performance parameter, the physical design and configuration of the transformer directly effect the operational range of both these parameters. High frequency transformers designs differ significantly from low frequency designs, particularly due to the need to accommodate the capacitance effects generated at high frequencies.

The present invention is primarily intended to operate in the frequency range classified as ‘extremely low frequency’ (30 Hz to 300 Hz), which covers the mains frequency (50-60 Hz) of the majority of land-based power systems. However, the present invention is equally adaptable for use with signals in the adjacent 300 Hz-3000 Hz range which covers harmonic frequency multiples of the mains frequencies and aircraft power system frequencies. Generically, all the aforesaid frequencies are considered as ‘low frequency’ and are typically associated with energy or power transfer in contrast to ‘high frequencies’ typically involved in information transfer, e.g. radio, microwave and so forth.

In a complimentary manner, the transformer application voltage is a design parameter which affects the physical configuration and size of the transformer. A high voltage transformer would require different insulation and winding configuration than a low voltage design. Typically, power transformers are designed for high voltage usage as they operate from the mains supply (typically 110V or 230V or above) or the distribution/transmission voltages of a national power system. As used herein, the term ‘high voltage’ is used to mean equal to or greater than a voltage of about 100V.

In a conventional 2 winding transformer, the flux linkage between windings is a function of core permeability, the number of turns in the winding, the primary/secondary winding separation, the core length and cross-sectional area. The core of a transformer is the medium through which the magnetic field propagates in linking the windings and its configuration and constituent material are critical transformer design parameters that can be broadly classified into three categories: full core, core-less and partial core.

A full-core forms a continuous and closed magnetic path, around which the windings are wound. A power transformer designed for high efficiency power transfer would typically employ a high permeability full core, confining the magnetic flux to the core material instead of passing through the air. The use of a full core allows magnetic flux to develop without requiring a large magnetization current. This aids both the efficiency and regulation of the transformer. The core would usually be formed from a ferromagnetic material to give a high volts per turn ratio, minimizing the quantity of winding material used and therefore reducing losses. The windings usually are made of low resistivity material (e.g. copper or aluminium), whilst the core material is usually laminated into high resistance paths (to reduce eddy current losses) and formed from materials with low hysteresis and high permeability values. Full-core transformers typically are used for low frequency applications, particularly in the power industry.

A core-less transformer has no ferromagnetic material passing through the windings. A conceptual core-less transformer would have a primary winding wound about the central non-conducting, non-magnetic former with a secondary winding wound about the primary winding, though the winding arrangement may be reversed or two windings may be wound together to reduce flux leakage. The absence of a core theoretically implies no hysteresis or eddy current losses (commonly referred to as core losses) and consequently the device should exhibit a linear magnetization curve.

However, a significant disadvantage of core-less transformers is that the magnetizing current drawn from the supply may be a significant percentage of the total on-load current due to a low magnetizing reactance, which is itself in direct proportion to the operational frequency. The combination of low frequency with a core-less design would render the transformer extremely ineffective. Consequently, practical core-less transformers usually are employed in high frequency applications.

One method of overcoming this problem is to increase the number of winding turns, though this naturally increases the quantity of winding material. Thus, although there are no core losses, the increase in winding losses and increased flux leakage due to the increased spatial displacement of the windings (with a corresponding reduction in efficiency) restricts the practical applications of such core-less transformer designs.

A partial core, normally formed from ferromagnetic or forrite laminated material addresses some of the deficiencies of a core-less transformer. As used herein, the term ‘partial core’ means a core in wheels. The core material is present predominantly within the internal space of the windings i.e., a major portion of the core lies within the windings. The core forms a non-closed, discontinuous magnetic path. Part of the coupling magnetic field of the transformer propagates through non-magnetic material, e.g. air.

In comparison to a full core, the reduced size of partial core reduces core and magnetization losses, whilst significant savings are possible in the core and winding material volumes. Partial core transformers have typically been used in high frequency applications.

However, despite the substantial prior art relating to all aspects of transformer design and operation a transformer incorporating the combination of low frequency, high voltage and a partial core (operating in either ambient or superconducting temperature conditions) has not been explored.

### DISCLOSURE OF INVENTION

It is therefore an object of the present invention to substantially ameliorate the aforesaid disadvantages by the provision of a partially cored transformer capable of operating at low frequency and high voltages.

It is a further object of the present invention to provide a power transformer capable of operating under ambient or superconducting temperature conditions.

The present invention prides a transformer designed to operate in the low frequency range of 30-3000 Hz at a primary voltage of the order of 100V or above, wherein said transformer includes a primary winding and a secondary winding both of electrically conductive material and configured to predominantly surround a partial core (as defined above); the primary winding and secondary winding are electrically insulated from each other and from the partial core, and are arranged such that a magnetic flux generated by the application of an alternating current to one of said windings links the other of said windings to induce a voltage therein; and wherein said partial core is made of ferromagnetic material and does not form a closed, continuous magnetic path.

Preferably, said core may be formed from a laminated construction.

Preferably, at least one of said windings is formed from high-temperature superconducting tape.

The said transformer may be capable of immersion in a cryogenic liquid to permit superconducting operation.

### BRIEF DESCRIPTION OF DRAWINGS

By way of example only, preferred embodiments of the present invention are described in detail with reference to the accompanying drawings, in which:

FIG. 1. shows a perspective view of a partial longitudinal section of a first embodiment of the present invention,

FIG. 2. shows an end view of a second embodiment of the present invention.

### BEST MODE FOR CARRYING OUT THE INVENTION

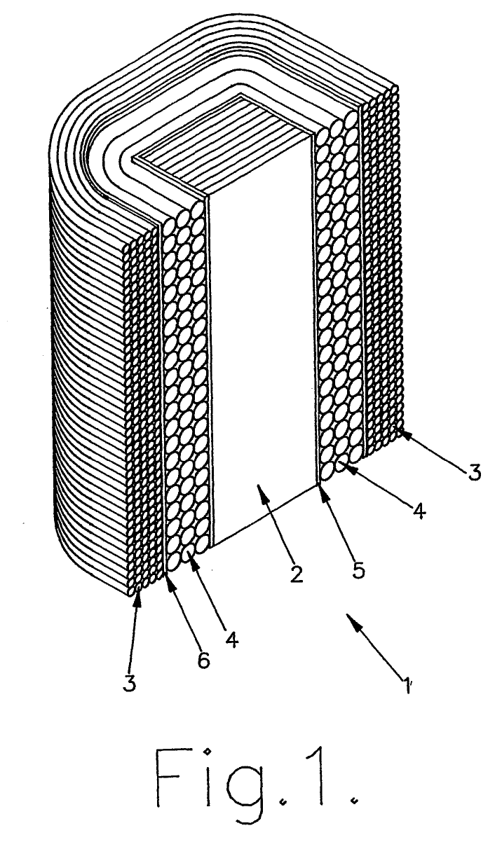

FIG. 1 shows a longitudinal section through the core and winding assembly of a power transformer according to a preferred embodiment of the present invention. The transformer 1 consists of a partial core 2, a primary winding 3 and a secondary winding 4. In this embodiment, the partial core 2 may be made of a metallic, ferromagnetic material, formed as a solid elongated element with a constant rectangular cross-section and laminated to reduce eddy current losses. The partial core 2 is enveloped about its longitudinal length by a central former 5 with a longitudinal slit, formed from a non-magnetic non-conducting or conducting material.

The secondary low voltage winding 4 is wound directly about the exterior surface of the former 5 in the series of concentric layers and is connected to a suitable AC power outlet (not shown). The outer layer of the secondary windings 4 is covered by an insulating layer 6 about which the primary winding 3 is directly wound in a corresponding series of concentric layers. The ends of the primary winding 3 are connected to a single or three phase input AC power supply with a frequency between 30 HZ to 3000 Hz. The winding 3,4 materials will typically be copper or aluminium wire to minimize the effects of winding heating losses.

As will be appreciated by those versed in the art, the position of the primary and secondary windings 3,4 may be reversed, or be wound concurrently.

Although the partial core may extend beyond the volume enclosed by the turns of the windings 3,4 it does not form a complete, continuous closed magnetic path.

In either of the aforesaid embodiments, the windings 3,4 or the entire transformer unit 1 may be immersed in a cryogenic liquid such as liquid nitrogen. This permits a sufficient reduction in the operating temperature of the transformer 1 to enable superconduction, effectively creating zero resistance and thus generating zero heat losses in the windings.

In the case of a transformer specifically designed for operation at superconducting temperatures, the material used to form one or both of the windings 3,4 can be high-temperature superconducting tape.

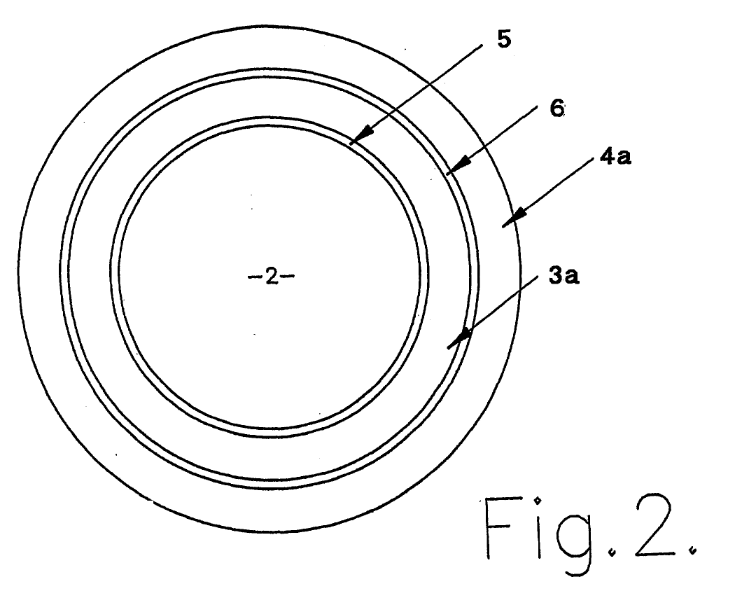

Naturally, the transformer need not be square/rectangular in cross-section and FIG. 2 shows a corresponding cross-section of an alternative embodiment with a circular configuration.

In this embodiment, the partial core 2, former 5 and insulating layer 6 all are as described with reference to FIG. 1, apart from being of circular, rather than rectangular, cross-section.

However, the primary winding 3a is wound on the former 5, and the secondary winding 4a is wound over the insulating layer 6, surrounding the primary.

In all other respects, the FIG. 2 embodiment is constructed and operates as the FIG. 1 embodiment.

The type of transformer described with reference to FIG. 2 (but of rectangular cross-section) has been found to be suitable for incorporation into an arc welder.

This arc welder is designed to operate off the mains supply, with an operational frequency of 50 Hz and a primary voltage of 230V rms.

The partial core 2 is made of laminated ferromagnetic material, with the laminations 0.5 mm thick, forming partial core 195 mm long with a rectangular cross-section of 38×43 mm. The laminations are enclosed in a tube 5 of insulation material to hold them together. The tube 5 also provides electrical insulating between the core 2 and the primary winding 3a, and acts as a former for the primary winding.

The primary winding 3a consist of 836 turns of 1.9 mm diameter copper wire, wound in ten layers around the tube 5.

An insulating layer 6 insulates the primary winding 3a from the secondary winding 4a, which consists of 158 turns of 4 mm copper wire, wound in four layers.

The external diameter of the welder is 130 mm, with a weight of approximately 14 kg.

In operation, the secondary winding was terminated with one connection to the metal to be welded and the other connection to an appropriately-sized welding rod (e.g. 2.6 mm diameter) of a metal similar to that to be welded. Arc welding is then achieved in the usual manner, by striking an arc between the welding rod and the metal to be welded.

The striking or open circuit secondary voltage is 44V. Under these conditions, the primary current is 11A. Under arcing conditions, the secondary voltage is 24V, with a secondary current of 95A and a primary current of 22A. The supply power factor is 0.98 lagging. The duty cycle for the welder is estimated to be approximately 25%.

The above-described performance can be compared to that of a commercially available full core transformer based welder, with name plate readings for a 50 Hz, 230V, 10A supply, duty cycle of 26% and a nominal welding rod current of 105A for a 2.5 mm diameter welding rod. The transformer core dimensions are 155×135×90 mm, with windings of the order of 35×35 mm cross-sectional area. The transformer weighs 18 kg.

The transformer of the present invention is significantly simpler in design than a conventional (i.e. full-core) transformer, and as a result is simpler and thus cheaper to manufacture, but without any sacrifice of efficiency of operation.

1. A transformer designed to operate in the low frequency range of 30-3000 Hz at a primary voltage of the order of 100V or above, wherein said transformer includes a primary winding and a secondary winding both of electrically conductive material and configured to predominantly surround a partial core (as hereinbefore defined): the primary winding and secondary winding are electrically insulated from each other and from the partial core, and are arranged such that a magnetic flux generated by the application of an alternating current to one of said windings links the other of said windings to induce a voltage therein; and wherein said partial core is made of ferromagnetic material and does not form a closed, continuous magnetic path.

2. The transformer as claimed in claim 1, wherein the primary winding surrounds the secondary winding.

3. The transformer as claimed in claim 1, wherein the secondary winding surrounds the primary winding.

4. The transformer as claimed in claim 1, wherein the primary and secondary windings are wound concurrently.

5. The transformer as claimed in any one of the preceding claims wherein the core is laminated.

6. The transformer as claimed in any one of the preceding claims wherein one of said windings is made of high-temperature super conducting tape.

7. The transformer as claimed in any one of claims 1-5, wherein both of said windings are made of high-temperature superconducting tape.

8. An arc welder incorporating a transformer as claimed in any one of the preceding claims.

9. A method of operating a transformer as claimed in any one of claims 1-7, wherein said primary winding is connected to an alterating-current power supply having a frequency in the range 30-3000 Hz and a voltage of the order of 100V or greater.

10. A method of operating a transformer as claimed in claim 6 or claim 7, wherein said transformer is immersed in a cryogenic liquid.
